(19) United States
(12) Patent Application Publication
(10) Pub. No.: US 2013/0095820 A1
(43) Pub. Date: Apr. 18, 2013

(54) WIRELESS COMMUNICATION TERMINAL AND CONTROL METHOD FOR THE SAME

(71) Applicant: Chikara YASUDA, Nerima (JP)

(72) Inventor: Chikara YASUDA, Nerima (JP)

(73) Assignee: FUJITSU MOBILE COMMUNICATIONS LIMITED, Kawasaki-shi (JP)

(21) Appl. No.: 13/612,030

(22) Filed: Sep. 12, 2012

(30) Foreign Application Priority Data
Oct. 14, 2011 (JP) 2011-227450

(51) Int. Cl. H04W 88/06; H04W 36/08

(52) U.S. Cl. 455/426.1

(57) ABSTRACT

A 3G wireless control unit, a WiFi wireless control unit, and a WiMAX wireless control unit each select one data communication method from data communication methods that each supports, and any one supporting the selected data communication method performs communication using the selected data communication method. A 3G non-coverage area search processing unit, a WiFi non-coverage area search processing unit, and a WiMAX non-coverage area search processing unit each detect a base station supporting a data communication method that each supports. A search control unit controls the frequency of execution of a base-station detecting process performed by the WiMAX non-coverage area search processing unit on the basis of respective communication states and predetermined priorities of data communication methods.

### CROSS-REFERENCE TO RELATED APPLICATION

This application is based upon and claims the benefit of priority of the prior Japanese Patent Application No. 2011-227450, filed on Oct. 14, 2011, the entire contents of which are incorporated herein by reference.

### FIELD

The embodiments discussed herein are directed to a wireless communication terminal and a method for controlling the wireless communication terminal.

### BACKGROUND

In recent years, various data communication methods, such as the 3G (3rd Generation) cellular phone method, fixed wireless communication standards (WiMax™ (Worldwide Interoperability for Microwave Access)), and wireless LAN standards (WiFi™ (Wireless Fidelity)), have been proposed. The data communication methods provide a variety of transmission rates and communication ranges. In general, a transmission rate and a communication range are in a trade-off relationship; therefore, it is difficult to simultaneously achieve a high transmission rate and a wide communication range in a single wireless transmission system.

Consequently, communication suitable for an operator's demand is established by switching among data communication methods depending on the situation. In such a case, respective cells of different data communication methods may adjoin or overlap with each other. In a wireless communication system having a plurality of data communication methods as just described, a wireless communication terminal performs a search to determine whether there is any base station or access point supporting a data communication method that the wireless communication terminal supports in order to perform communication using the data communication method.

Conventional technologies for such a search of an access point include a technology of changing the interval to perform a search depending on the communication quality (for example, Japanese Laid-open Patent Publication No. 2008-061015). Furthermore, as a wireless communication system using a plurality of data communication methods, there is proposed a conventional technology to determine which data wireless communication method is used to acquire standby paging on the basis of the priority order or the signal strength (for example, Japanese Laid-open Patent Publication No. 2006-262178). Moreover, there is proposed a conventional technology to perform handover by determining a wireless base station as a destination of handover on the basis of respective priorities of data communication methods (for example, Japanese Laid-open Patent Publication No. 2008-131587).

However, in the conventional search methods, problems arise when, in a state where a high-priority data communication method based on a communication rate and a communication range, etc. is being used, a data communication method of which the priority is lower than that of the high-priority data communication method is low is unlikely to be used. Namely, in such a case, in spite of the fact that the lower-priority data communication method is unlikely to be used, a search using the lower-priority data communication method is frequently performed. Furthermore, also when the radio quality of the high-priority data communication method is good, a search using the lower-priority data communication method is frequently performed. Moreover, when three or more data communication methods are used, a search using all the data communication methods is not requested to be frequently performed. In this manner, in spite of the fact that normally, there is little advantage of frequently performing a search using any of data communication methods, a search using the data communication method is frequently performed, resulting in wasteful power consumption, and therefore, it is difficult to reduce power consumption.

Furthermore, even if the conventional technology of changing the interval to perform a search depending on the communication quality is used, a fruitless search using a data communication method by which a search does not actually have to be performed so often arises, so it is difficult to reduce power consumption. Moreover, even if any of the technology to determine a data wireless communication method for standby paging and the technology to determine a destination of handover on the basis of priorities is used, a fruitless search arises, so it is difficult to reduce power consumption.

### SUMMARY

According to an aspect of an embodiment, a wireless communication terminal includes, a wireless communication unit that selects one data communication method from a plurality of data communication methods, and performs communication using the selected data communication method, a search processing unit that detects a base station supporting a data communication method other than the data communication method selected by the wireless communication unit, and a search control unit that controls frequency of execution of a base-station detecting process performed by the search processing unit using the data communication method other than the data communication method being used in the communication on the basis of respective communication states and predetermined priorities of the plurality of data communication methods.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating communication areas in a case where there is a plurality of different data communication methods;

FIG. 2 is a block diagram of a wireless communication terminal according to embodiments;

FIG. 3 is a diagram of an example of a search-frequency determining table according to a first embodiment;

FIG. 4 is a flowchart of a WiMAX search control determining process in the first embodiment;

FIG. 5 is a flowchart of a WiMAX communication non-coverage area search frequency determining process in the first embodiment;

FIG. 6 is a diagram of an example of a search-frequency determining table according to a second embodiment;

FIG. 7 is a flowchart of a WiMAX communication non-coverage area search frequency determining process in the second embodiment;

FIG. 8 is a diagram of an example of a search-frequency determining table according to a third embodiment;

FIG. 9 is a flowchart of a WiMAX communication non-coverage area search frequency determining process in the third embodiment; and

FIG. 10 is a diagram illustrating a hardware configuration of the wireless communication terminal.

### DESCRIPTION OF EMBODIMENTS

Preferred embodiments of the present invention will be explained with reference to accompanying drawings. Incidentally, the wireless communication terminal and the method for controlling the wireless communication terminal according to the present invention are not limited by the embodiments. The wireless communication terminal includes, for example, a cell-phone unit, a smartphone, and the like; however, the wireless communication terminal is not limited to these, and can be any other units that establish wireless communication using a plurality of data communication methods.

### [a] First Embodiment

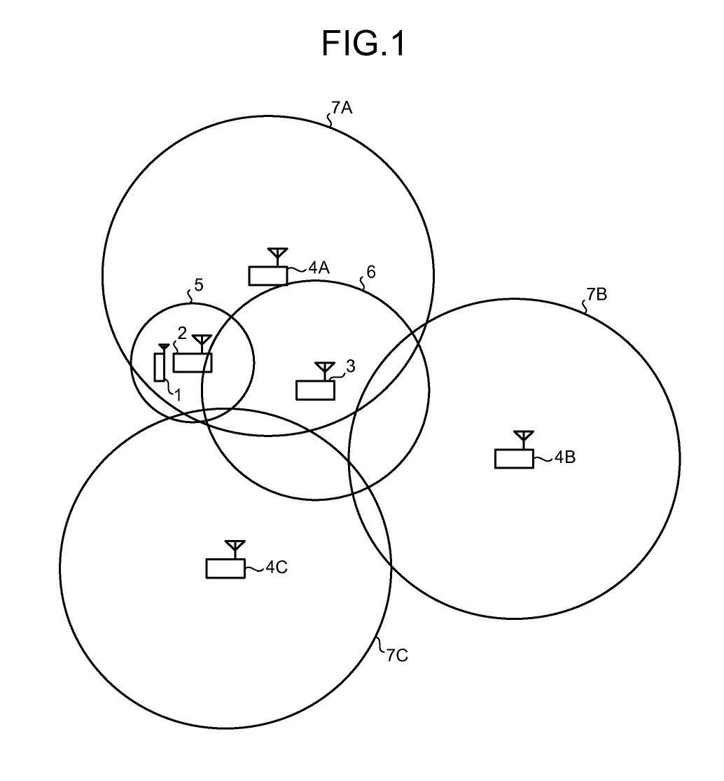

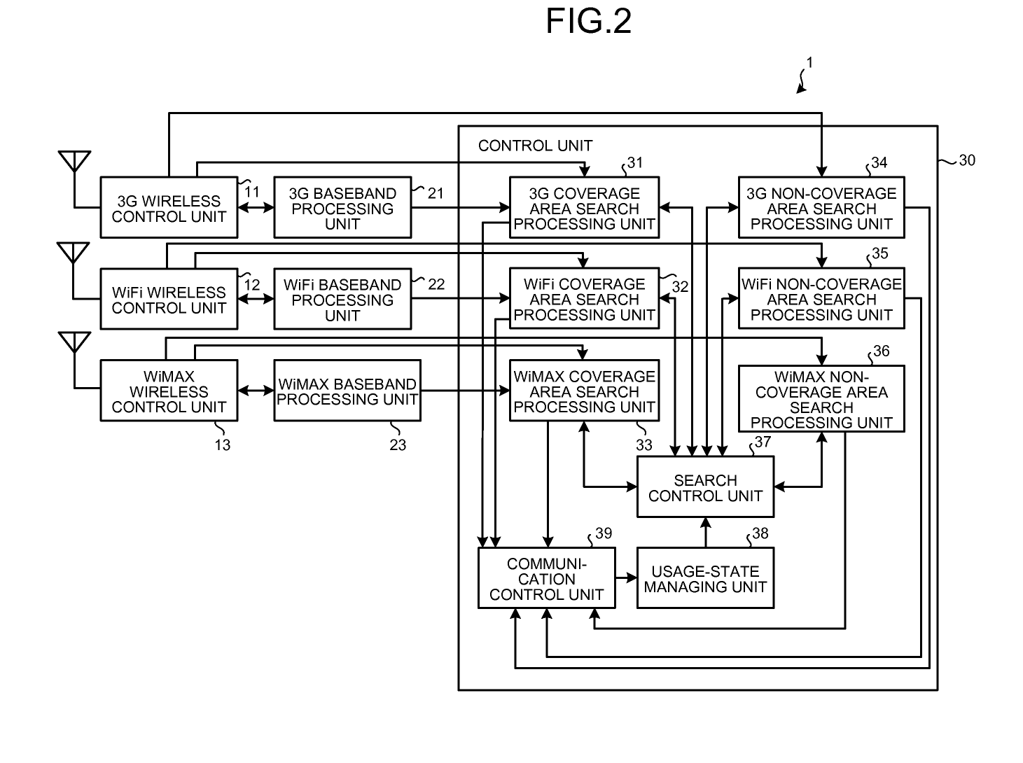

FIG. 1 is a diagram illustrating communication areas in a case where there is a plurality of different data communication methods. FIG. 2 is a block diagram of a wireless communication terminal according to embodiments.

A wireless communication terminal 1 according to a first embodiment establishes wireless communication using 3G communication, WiMAX communication, and WiFi communication as data communication methods. A base station 2 in FIG. 1 is a WiFi access point. A communication area 5 is a communication area of the base station 2. A base station 3 is a WiMAX access point. A communication area 6 is a communication area of the base station 3. Base stations 4A to 4C are base stations of the 3G communication. A communication area 7A is a communication area of the base station 4A. A communication area 7B is a communication area of the base station 4B. A communication area 7C is a communication area of the base station 4C. In the description below, the WiFi and WiMAX access points are also referred to as the “base station”.

As illustrated in FIG. 1, the 3G communication covers the widest communication area, followed by the WiMAX communication, and then the WiFi communication. On the contrary, the WiFi communication provides the highest transmission rate, followed by the WiMAX communication, and then the 3G communication. It is conceivable that a user of the wireless communication terminal 1 wants communication at a higher transmission rate; therefore, in the present embodiment, a higher priority is placed on a data communication method with a higher transmission rate. Namely, in the present embodiment, there is described a case where the WiFi communication is given the highest priority, followed by the WiMAX communication, and then the 3G communication. However, the priority order can be determined on the basis of another factor; for example, the priority order of the data communication methods can be determined on the basis of the size of communication area.

In a state of FIG. 1, the wireless communication terminal 1 is within the communication area 5 of the WiFi communication and the communication area 7A of the 3G communication. Furthermore, in the state of FIG. 1, the wireless communication terminal 1 is not within any communication area of the WiMAX communication including the communication area 6. When the wireless communication terminal 1 is within a certain communication area, the wireless communication terminal 1 can establish communication with a base station having the communication area by using a data communication method corresponding to the base station. Namely, in the state of FIG. 1, the wireless communication terminal 1 can establish communication with the base station 2 using the WiFi communication. Furthermore, the wireless communication terminal 1 can establish communication with the base station 4A using the 3G communication. However, in the state of FIG. 1, it is difficult that the wireless communication terminal 1 establishes communication using the WiMAX communication. Furthermore, for example, when the wireless communication terminal 1 has moved to a location where the communication area 6 has an overlap with only the communication area 7A from the state of FIG. 1, the wireless communication terminal 1 can communicate with the base station 4A using the 3G communication, and can communicate with the base station 3 using the WiMAX communication. However, in this case, it is difficult that the wireless communication terminal 1 establishes communication using the WiFi communication.

In this manner, when the wireless communication terminal 1 has moved from the state of being in communication with a base station having a certain communication area and deviated from the communication area, the wireless communication terminal 1 performs handover to switch the connection to a base station of which the communication area contains a moving destination and continue the communication. Therefore, the wireless communication terminal 1 detects a base station which could be a destination of the handover in advance. Such detection of a base station is referred to as a “search”.

Then, a search operation that the wireless communication terminal 1 periodically performs to detect the existence or non-existence of an electric field from a base station since a data communication unit has determined that the wireless communication terminal 1 is out of an electric field from a base station until the wireless communication terminal 1 comes within the electric field is referred to as a “non-coverage area search”. Here, being out of an electric field indicates that the wireless communication terminal 1 is out of a communication area of a base station having the electric field; on the other hand, being within an electric field indicates that the wireless communication terminal 1 is within a communication area having the electric field. Furthermore, a search operation that the wireless communication terminal 1 periodically performs to measure the strength of an electric field from a base station since an electric field from a base station in data communication has been detected and it has been determined that the wireless communication terminal 1 is within the electric field until it is detected that the wireless communication terminal 1 is out of the electric field is referred to as a “coverage area search”.

The non-coverage area search and coverage area search are explained taking, for example, the 3G communication as a data communication method. In a non-coverage area search, a radio frequency and a diffusion code are unknown, so whether electric field strength equal to or higher than a predetermined threshold (a received signal strength indicator (RSSI)) is detected in any radio frequency is implemented as a search operation. The electric field strength may also be referred to as “received signal strength”. On the other hand, a coverage area search is implemented as a search operation to measure an energy value as a result of code demodulation using a known radio frequency and a known diffusion code. When the wireless communication terminal 1 in the state of periodically performing the coverage area search operation has moved, thereby becoming unable to detect the strength of an electric field from a base station and determines to be out of service, the wireless communication terminal 1 makes the transition to the state of periodically performing the non-coverage area search operation. Furthermore, when the wireless communication terminal 1 in the state of periodically performing the non-coverage area search operation has moved, thereby becoming able to detect the strength of an electric field from a base station and determines to be within a coverage area, a radio frequency and a diffusion code are identified, and the wireless communication terminal 1 makes the transition to the state of periodically performing the coverage area search operation.

Subsequently, a detailed configuration of the wireless communication terminal 1 according to the present embodiment is explained. As illustrated in FIG. 2, the wireless communication terminal 1 according to the present embodiment includes a 3G wireless control unit 11, a WiFi wireless control unit 12, and a WiMAX wireless control unit 13. Furthermore, the wireless communication terminal 1 according to the present embodiment includes a 3G baseband processing unit 21, a WiFi baseband processing unit 22, a WiMAX baseband processing unit 23, and a control unit 30. The control unit 30 includes a 3G coverage area search processing unit 31, a WiFi coverage area search processing unit 32, a WiMAX coverage area search processing unit 33, a 3G non-coverage area search processing unit 34, a WiFi non-coverage area search processing unit 35, and a WiMAX non-coverage area search processing unit 36. Furthermore, the control unit 30 includes a search control unit 37, a usage-state managing unit 38, and a communication control unit 39. In the following description, various search processing and communication switching control based on a result of the search processing, which are primary objects of the present application, are explained, and description of the operation involved in transmission and reception of data to be communicated is omitted.

The 3G wireless control unit 11 receives a radio signal transmitted from a base station through 3G communication (hereinafter, referred to as a “3G signal”) via an antenna. The 3G wireless control unit 11 performs a frequency conversion to a baseband on the received 3G signal, and generates a baseband signal. The 3G wireless control unit 11 outputs the 3G signal, which is the baseband signal, to the 3G baseband processing unit 21.

Furthermore, the 3G wireless control unit 11 outputs information for measurement of electric field strength based on a pilot signal contained in the received 3G signal to the 3G coverage area search processing unit 31 and the 3G non-coverage area search processing unit 34. The information for measurement of electric field strength is, for example, a control amount of automatic gain control (AGC) for controlling gain of an attenuator for attenuating a radio signal. The pilot signal for 3G communication, which is the baseband signal, is subjected to a correlation operation with a diffusion code in the 3G baseband processing unit 21, and an energy value obtained as a result of the correlation operation is output to the 3G coverage area search processing unit 31.

The WiFi wireless control unit 12 receives a radio signal transmitted from a base station through WiFi communication (hereinafter, referred to as a “WiFi signal”) via an antenna. The WiFi wireless control unit 12 performs a frequency conversion to a baseband on the received WiFi signal, and generates a baseband signal. The WiFi wireless control unit 12 outputs the WiFi signal, which is the baseband signal, to the WiFi baseband processing unit 22.

Furthermore, the WiFi wireless control unit 12 outputs information for measurement of electric field strength based on a pilot signal contained in the received WiFi signal to the WiFi coverage area search processing unit 32 and the WiFi non-coverage area search processing unit 35. Moreover, for a coverage area search, the WiFi wireless control unit 12 outputs the pilot signal for WiFi communication, which is the baseband signal, to the WiFi baseband processing unit 22.

The WiMAX wireless control unit 13 receives a radio signal transmitted from a base station through WiMAX communication (hereinafter, referred to as a “WiMAX signal”) via an antenna. The WiMAX wireless control unit 13 performs a frequency conversion to a baseband on the received WiMAX signal, and generates a baseband signal. The WiMAX wireless control unit 13 outputs the WiMAX signal, which is the baseband signal, to the WiMAX baseband processing unit 23.

Furthermore, the WiMAX wireless control unit 13 outputs information for measurement of electric field strength based on a pilot signal contained in the received WiMAX signal to the WiMAX coverage area search processing unit 33 and the WiMAX non-coverage area search processing unit 36. Moreover, for a coverage area search, the WiMAX wireless control unit 13 outputs the pilot signal for WiFi communication, which is the baseband signal, to the WiMAX baseband processing unit 23.

The 3G baseband processing unit 21 receives input of a 3G signal, which is a baseband signal, from the 3G wireless control unit 11. Then, the 3G baseband processing unit 21 demodulates the received 3G signal at a baseband frequency. And then, the 3G baseband processing unit 21 outputs the demodulated 3G signal to the 3G coverage area search processing unit 31.

The WiFi baseband processing unit 22 receives input of a WiFi signal, which is a baseband signal, from the WiFi wireless control unit 12. Then, the WiFi baseband processing unit 22 demodulates the received WiFi signal at a baseband frequency. And then, the WiFi baseband processing unit 22 outputs the demodulated WiFi signal to the WiFi coverage area search processing unit 32.

The WiMAX baseband processing unit 23 receives input of a WiMAX signal, which is a baseband signal, from the WiMAX wireless control unit 13. Then, the WiMAX baseband processing unit 23 demodulates the received WiMAX signal at a baseband frequency. And then, the WiMAX baseband processing unit 23 outputs the demodulated WiMAX signal to the WiMAX coverage area search processing unit 33.

The 3G coverage area search processing unit 31 receives an instruction to perform a coverage area search from the search control unit 37. Then, the 3G coverage area search processing unit 31 measures electric field strength of a received 3G signal using information for measurement of electric field strength input from the 3G wireless control unit 11 at a predetermined frequency, and determines whether the wireless communication terminal 1 is within a 3G coverage area by comparing the measured electric field strength with a 3G coverage area threshold. Here, the 3G coverage area threshold is a predetermined threshold for determining whether the wireless communication terminal 1 is within a communication area of a base station for 3G communication. In the present embodiment, for example, the 3G coverage area search processing unit 31 measures electric field strength of a received 3G signal at a search frequency of once every 5 to 10 seconds. In what follows, the search frequency of once every 5 to 10 seconds is referred to as a regular frequency. When determined to be within the 3G coverage area, the 3G coverage area search processing unit 31 further performs identification of a radio frequency and a diffusion code on a 3G signal input from the 3G baseband processing unit 21 to identify a source base station that transmitted the received 3G signal. At this time, the 3G coverage area search processing unit 31 measures strength of an electric field received from each base station on the basis of an energy value obtained from the 3G baseband processing unit 21. Then, the 3G coverage area search processing unit 31 outputs identification information of the base station and the measured electric field strength to the communication control unit 39.

Furthermore, when electric field strength of a 3G signal from a base station is below the 3G coverage area threshold, the 3G coverage area search processing unit 31 determines that the wireless communication terminal 1 is outside of a communication area of the base station. Then, when the wireless communication terminal 1 is outside of any communication area for 3G communication (hereinafter, referred to as “out of 3G communication service”), the 3G coverage area search processing unit 31 notifies the search control unit 37 of information about the wireless communication terminal 1 being out of 3G communication service. When the wireless communication terminal 1 is out of 3G communication service, the 3G coverage area search processing unit 31 stops the search operation.

The WiFi coverage area search processing unit 32 receives an instruction to perform a coverage area search from the search control unit 37. Then, the WiFi coverage area search processing unit 32 measures electric field strength of a received WiFi signal using information for measurement of electric field strength input from the WiFi wireless control unit 12, for example, at the regular frequency. Furthermore, the WiFi coverage area search processing unit 32 identifies a source base station from the WiFi signal input from the WiFi baseband processing unit 22. Then, the WiFi coverage area search processing unit 32 outputs identification information of the base station and the measured electric field strength to the communication control unit 39.

Furthermore, when electric field strength of a WiFi signal from a base station is below a WiFi coverage area threshold, the WiFi coverage area search processing unit 32 determines that the wireless communication terminal 1 is outside of a communication area of the base station. Here, the WiFi coverage area threshold is a predetermined threshold for determining whether the wireless communication terminal 1 is within a communication area of a base station for WiFi communication. Then, when the wireless communication terminal 1 is outside of any communication area for WiFi communication (hereinafter, referred to as “out of WiFi communication service”), the WiFi coverage area search processing unit 32 notifies the search control unit 37 of information about the wireless communication terminal 1 being out of WiFi communication service. When the wireless communication terminal 1 is out of WiFi communication service, the WiFi coverage area search processing unit 32 stops the search operation.

The WiMAX coverage area search processing unit 33 receives an instruction to perform a coverage area search from the search control unit 37. Then, the WiMAX coverage area search processing unit 33 measures electric field strength of a received WiMAX signal using information for measurement of electric field strength input from the WiMAX wireless control unit 13, for example, at the regular frequency. Furthermore, the WiMAX coverage area search processing unit 33 identifies a source base station from the WiMAX signal input from the WiMAX baseband processing unit 23. Then, the WiMAX coverage area search processing unit 33 outputs identification information of the base station and the measured electric field strength to the communication control unit 39.

Furthermore, when electric field strength of a WiMAX signal from a base station is below a WiMAX coverage area threshold, the WiMAX coverage area search processing unit 33 determines that the wireless communication terminal 1 is outside of a communication area of the base station. Here, the WiMAX coverage area threshold is a predetermined threshold for determining whether the wireless communication terminal 1 is within a communication area of a base station for WiMAX communication. Then, when the wireless communication terminal 1 is outside of any communication area for WiMAX communication (hereinafter, referred to as “out of WiMAX communication service”), the WiMAX coverage area search processing unit 33 notifies the search control unit 37 of information about the wireless communication terminal 1 being out of WiMAX communication service. When the wireless communication terminal 1 is out of WiMAX communication service, the WiMAX coverage area search processing unit 33 stops the search operation.

The 3G non-coverage area search processing unit 34 receives an instruction to perform a non-coverage area search from the search control unit 37. Then, the 3G non-coverage area search processing unit 34 measures electric field strength of a received 3G signal using information for measurement of electric field strength input from the 3G wireless control unit 11, for example, at the regular frequency, and detects a base station of which the electric field strength exceeds the 3G coverage area threshold. Such detection of a base station capable of 3G communication by the 3G non-coverage area search processing unit 34 is a 3G communication non-coverage area search. Then, when detected a base station for 3G communication, the 3G non-coverage area search processing unit 34 determines that the wireless communication terminal 1 is within a 3G communication coverage area. Then, when the wireless communication terminal 1 is within the 3G communication coverage area, the 3G non-coverage area search processing unit 34 notifies the search control unit 37 of information about the wireless communication terminal 1 being within the 3G communication coverage area. When determined that the wireless communication terminal 1 is within the 3G communication coverage area, the 3G non-coverage area search processing unit 34 stops the search operation.

The WiFi non-coverage area search processing unit 35 receives an instruction to perform a non-coverage area search from the search control unit 37. Then, the WiFi non-coverage area search processing unit 35 measures electric field strength of a received WiFi signal using information for measurement of electric field strength input from the WiFi wireless control unit 12, for example, at the regular frequency, and detects a base station of which the electric field strength exceeds the WiFi coverage area threshold. Such detection of a base station capable of WiFi communication by the WiFi non-coverage area search processing unit 35 is a WiFi communication non-coverage area search. Then, when detected a base station for WiFi communication, the WiFi non-coverage area search processing unit 35 determines that the wireless communication terminal 1 is within a WiFi communication coverage area. Then, when the wireless communication terminal 1 is within the WiFi communication coverage area, the WiFi non-coverage area search processing unit 35 notifies the search control unit 37 of information about the wireless communication terminal 1 being within the WiFi communication coverage area. When determined that the wireless communication terminal 1 is within the WiFi communication coverage area, the WiFi non-coverage area search processing unit 35 stops the search operation.

The WiMAX non-coverage area search processing unit 36 receives a specification of a search frequency and an instruction to perform a non-coverage area search from the search control unit 37. Here, the specification of a search frequency includes a specification not to perform a search. Then, the WiMAX non-coverage area search processing unit 36 measures electric field strength of a received WiMAX signal using information for measurement of electric field strength input from the WiMAX wireless control unit 13 at the specified search frequency, and detects a base station of which the electric field strength exceeds the WiMAX coverage area threshold. Such detection of a base station capable of WiMAX communication by the WiMAX non-coverage area search processing unit 36 is a WiMAX communication non-coverage area search. Furthermore, when received a specification of a search frequency from the search control unit 37 during execution of a non-coverage area search, the WiMAX non-coverage area search processing unit 36 changes the frequency of non-coverage area search to the specified search frequency, and continues the non-coverage area search. Then, when detected a base station for WiMAX communication, the WiMAX non-coverage area search processing unit 36 determines that the wireless communication terminal 1 is within a WiMAX communication coverage area. Then, when the wireless communication terminal 1 is within the WiMAX communication coverage area, the WiMAX non-coverage area search processing unit 36 notifies the search control unit 37 of information about the wireless communication terminal 1 being within the WiMAX communication coverage area. When determined that the wireless communication terminal 1 is within the WiMAX communication coverage area, the WiMAX non-coverage area search processing unit 36 stops the search operation.

Here, even if not to perform a search is specified as the search frequency, when the wireless communication terminal 1 fails to establish WiFi communication, the wireless communication terminal 1 switches the data communication method to 3G communication, and the WiMAX non-coverage area search processing unit 36 performs a WiMAX communication non-coverage area search. Then, the WiMAX non-coverage area search processing unit 36 detects a base station for WiMAX communication. Accordingly, the wireless communication terminal 1 can switch the data communication method to WiMAX communication. In this manner, by controlling not to perform a WiMAX non-coverage area search while the wireless communication terminal 1 is using WiFi, a time to perform 3G communication is shortened, and therefore, it is possible to suppress a decrease in transmission rate.

The usage-state managing unit 38 receives a notification of information on a data communication method being used in communication from the communication control unit 39. Then, when received the notification of information on the data communication method from the communication control unit 39, the usage-state managing unit 38 notifies the search control unit 37 of the information on the data communication method being used in communication. Furthermore, the usage-state managing unit 38 stores therein the information on the data communication method being used in communication.

When received information about the wireless communication terminal 1 being within the 3G coverage area from the 3G non-coverage area search processing unit 34, the search control unit 37 notifies the 3G coverage area search processing unit 31 of an instruction to perform a coverage area search. Furthermore, when received information about the wireless communication terminal 1 being within the WiFi coverage area from the WiFi non-coverage area search processing unit 35, the search control unit 37 notifies the WiFi coverage area search processing unit 32 of an instruction to perform a coverage area search. Moreover, when received information about the wireless communication terminal 1 being within the WiMAX coverage area from the WiMAX non-coverage area search processing unit 36, the search control unit 37 notifies the WiMAX coverage area search processing unit 33 of an instruction to perform a coverage area search.

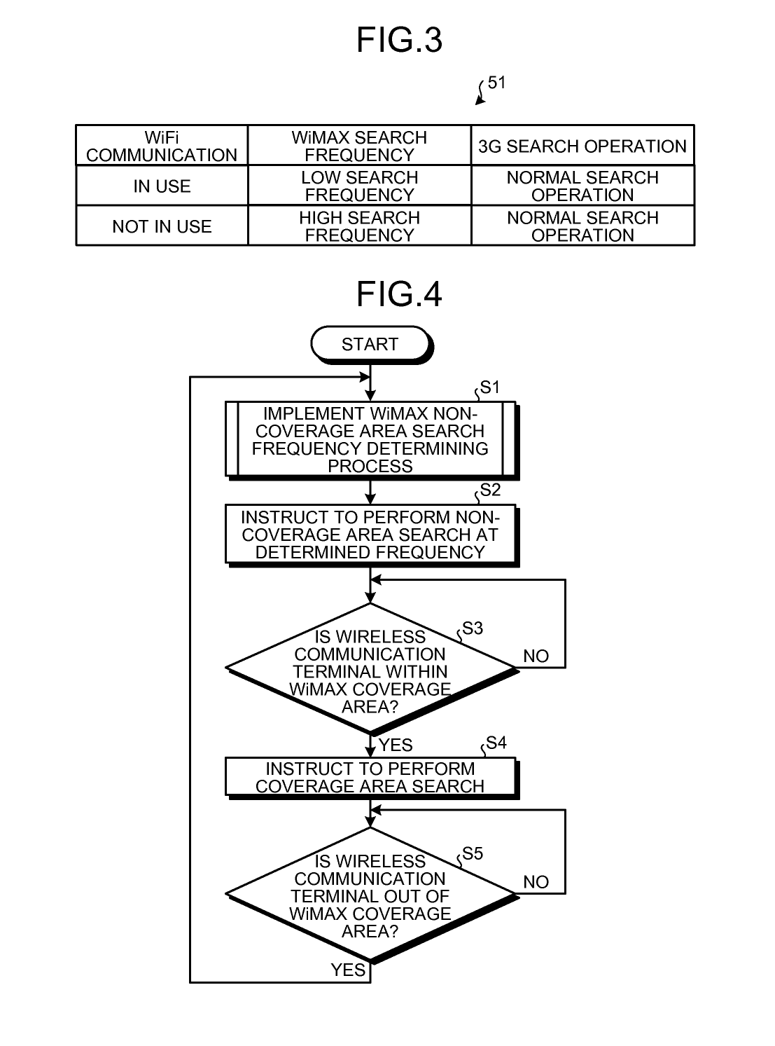

Furthermore, the search control unit 37 stores therein a search-frequency determining table 51 as illustrated in FIG. 3. Then, when received information about the wireless communication terminal 1 being out of the 3G coverage area from the 3G coverage area search processing unit 31, the search control unit 37 notifies the 3G non-coverage area search processing unit 34 of an instruction to perform a non-coverage area search. Furthermore, when received information about the wireless communication terminal 1 being out of the WiFi coverage area from the WiFi coverage area search processing unit 32, the search control unit 37 notifies the WiFi non-coverage area search processing unit 35 of an instruction to perform a non-coverage area search.

Moreover, when received information about the wireless communication terminal 1 being out of the WiMAX coverage area from the WiMAX coverage area search processing unit 33, the search control unit 37 acquires information on a data communication method being used in communication at the time from the usage-state managing unit 38. The search control unit 37 acquires a search frequency of WiMAX communication non-coverage area search corresponding to the acquired data communication method being used in communication from the search-frequency determining table 51. Specifically, when the wireless communication terminal 1 is communicating using WiFi communication, the search control unit 37 acquires a low search frequency as a search frequency of WiMAX non-coverage area search. Furthermore, when the wireless communication terminal 1 is not communicating using WiFi communication, the search control unit 37 acquires a high search frequency as a search frequency of WiMAX non-coverage area search. The high and low search frequencies here just represent a difference in frequency when the search frequencies are compared each other. For example, in the present embodiment, the high search frequency shall denote a regular search frequency, and the low search frequency shall denote no search to be made. Then, the search control unit 37 notifies the WiMAX non-coverage area search processing unit 36 of a specification of the acquired search frequency and an instruction to perform a non-coverage area search.

Furthermore, if there is a change in the data communication method, the search control unit 37 receives a notification of the change in the data communication method being used in communication from the usage-state managing unit 38. Then, the search control unit 37 determines whether the wireless communication terminal 1 is within the WiMAX coverage area. When the wireless communication terminal 1 is out of the WiMAX coverage area, the search control unit 37 acquires a search frequency of WiMAX communication non-coverage area search corresponding to the data communication method being used in communication from the search-frequency determining table 51. Then, the search control unit 37 notifies the WiMAX non-coverage area search processing unit 36 of a specification of the acquired search frequency.

Here, in the present embodiment, there is described the configuration that the search control unit 37 stores therein the search-frequency determining table illustrated in FIG. 3; however, it is not limited to this configuration. Namely, the search control unit 37 can set a search frequency of WiMAX communication non-coverage area search to low when WiFi communication is used and high when WiFi communication is not used.

The communication control unit 39 performs switching of the data communication method and handover processing. Specifically, when high-priority data communication methods can be used, the communication control unit 39 switches to use a higher-priority data communication method. For example, when the wireless communication terminal 1 has moved from a place including only the communication area 7A illustrated in FIG. 1 to a place where the communication area 7A has an overlap with the communication area 5, the communication control unit 39 switches the access point from the base station 4A to the base station 2, and switches the data communication method from 3G communication to WiFi communication. Furthermore, for example, when the wireless communication terminal 1 has moved from the communication area 7A illustrated in FIG. 1 to the communication area 7B, the communication control unit 39 switches the access point from the base station 4A to the base station 4B and performs handover.

Subsequently, WiMAX search control performed by the wireless communication terminal according to the present embodiment is explained with reference to FIG. 4. FIG. 4 is a flowchart of a WiMAX search control determining process in the first embodiment.

The search control unit 37 implements a process of determining a frequency of WiMAX communication non-coverage area search (Step S1).

Then, the search control unit 37 instructs the WiMAX non-coverage area search processing unit 36 to perform a non-coverage area search at the determined frequency (Step S2).

The WiMAX non-coverage area search processing unit 36 performs periodic measurement of electric field strength at the specified search frequency. Then, the WiMAX non-coverage area search processing unit 36 determines whether the wireless communication terminal 1 is within a WiMAX coverage area from a result of the measurement (Step S3). When the wireless communication terminal 1 is out of the WiMAX coverage area (NO at Step S3), the WiMAX non-coverage area search processing unit 36 repeatedly performs the periodic measurement of electric field strength at the specified search frequency.

On the other hand, when the wireless communication terminal 1 is within the WiMAX coverage area (YES at Step S3), the WiMAX non-coverage area search processing unit 36 notifies the search control unit 37 of the wireless communication terminal 1 being within the WiMAX coverage area. Then, the search control unit 37 instructs the WiMAX coverage area search processing unit 33 to perform a coverage area search (Step S4).

The WiMAX coverage area search processing unit 33 performs periodic measurement of electric field strength in response to the instruction from the search control unit 37. Then, the WiMAX coverage area search processing unit 33 determines whether the wireless communication terminal 1 is out of the WiMAX coverage area from a result of the measurement (Step S5). When the wireless communication terminal 1 is within the WiMAX coverage area (NO at Step S5), the WiMAX non-coverage area search processing unit 36 repeatedly performs the periodic measurement of electric field strength.

On the other hand, when the wireless communication terminal 1 is out of the WiMAX coverage area (YES at Step S5), the process control returns to Step S1. The wireless communication terminal 1 repeatedly performs Steps S1 to S5 until the operation ends.

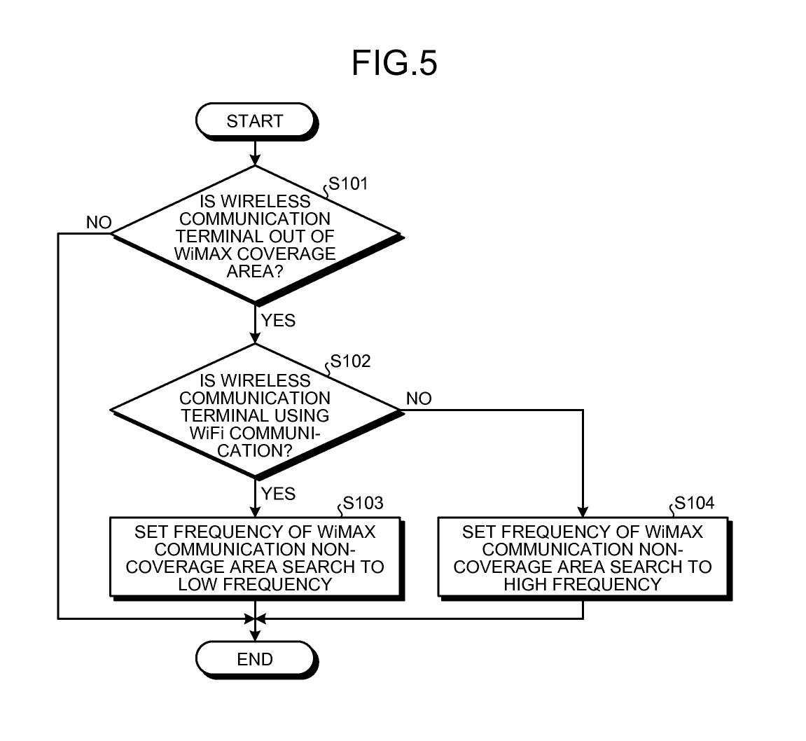

Subsequently, the WiMAX non-coverage area search frequency determining process performed by the wireless communication terminal according to the present embodiment is explained with reference to FIG. 5. FIG. 5 is a flowchart of the WiMAX non-coverage area search frequency determining process in the first embodiment. The flow of FIG. 5 is the process performed at Step S1 in FIG. 4. Here, there is described a case where the data communication method is changed.

Upon receipt of a notification of the change in the data communication method from the usage-state managing unit 38, the search control unit 37 determines whether the wireless communication terminal 1 is out of a WiMAX coverage area (Step S101). When the wireless communication terminal 1 is within the WiMAX coverage area (NO at Step S101), the search control unit 37 does not issue an instruction to perform a non-coverage area search, and ends the non-coverage area search frequency determining process.

On the other hand, when the wireless communication terminal 1 is out of the WiMAX coverage area (YES at Step S101), the search control unit 37 determines whether the wireless communication terminal 1 is using WiFi communication (Step S102). When the wireless communication terminal 1 is using WiFi communication (YES at Step S102), the search control unit 37 determines to set the frequency of WiMAX communication non-coverage area search to a low frequency (Step S103).

On the other hand, when the wireless communication terminal 1 is not using WiFi communication (NO at Step S102), the search control unit 37 determines to set the frequency of WiMAX communication non-coverage area search to a high frequency (Step S104).

In the flow of FIG. 5, there is described the case where the data communication method is changed; furthermore, when the wireless communication terminal 1 has moved from inside of the WiMAX coverage area to outside of the WiMAX coverage area, the search control unit 37 performs the processes at Steps S102 to S104 and determines the frequency of non-coverage area search in WiMAX communication.

Here, there is explained the reason why the frequency of WiMAX communication non-coverage area search can be lowered. When the wireless communication terminal 1 is using WiFi communication, it is unlikely that an operator who is moving uses the wireless communication terminal 1. Therefore, when the wireless communication terminal 1 is using WiFi communication, the probability of switching to the WiMAX communication is low; thus, it doesn't matter if the frequency of non-coverage area search in WiMAX communication having a lower priority than that of WiFi communication is lowered. Furthermore, also when the wireless communication terminal 1 is out of a communication area of WiFi communication, the communication continuity is ensured by 3G communication covering the widest communication area. Therefore, even if the wireless communication terminal 1 is out of the communication area for WiFi communication in a state where the wireless communication terminal 1 has not detected a base station for WiMAX communication because the search frequency in WiMAX communication is lowered, communication is continued by 3G communication. Moreover, when the data communication method is switched from WiFi communication to 3G communication, the frequency of WiMAX communication non-coverage area search is increased; thus, the wireless communication terminal 1 immediately detects a base station for WiMAX communication and switches from 3G communication to WiMAX communication, so a high transmission rate can be immediately ensured.

As described above, when using WiFi communication, the wireless communication terminal according to the present embodiment lowers the frequency of non-coverage area search in low-priority WiMAX communication. This makes it possible to reduce electric power consumed in a non-coverage area search in WiMAX communication when the wireless communication terminal is in WiFi communication. Furthermore, the communication continuity can be maintained due to the low possibility of movement in WiFi communication and the backup by 3G communication.

### [b] Second Embodiment

Subsequently, a second embodiment is explained. A wireless communication terminal according to the present embodiment differs in conditions for determination of the search frequency in WiMAX communication from the wireless communication terminal according to the first embodiment. So, a search-frequency determining process is mainly explained below. The wireless communication terminal according to the present embodiment is also expressed in the block diagram illustrated in FIG. 2. In the description below, a unit having the same reference numeral as in the first embodiment shall have the same function unless otherwise stated.

The WiFi coverage area search processing unit 32 outputs identification information of a base station and measured electric field strength to the communication control unit 39 and the search control unit 37.

The communication control unit 39 notifies the usage-state managing unit 38 of a data communication method being used in communication and identification information of a base station to connect to.

When received the data communication method and the identification information of the base station to connect to from the communication control unit 39, the usage-state managing unit 38 notifies the search control unit 37 of these. Furthermore, the usage-state managing unit 38 stores therein the received data communication method being used in communication and identification information of the other end of the communication, i.e., the base station to connect to.

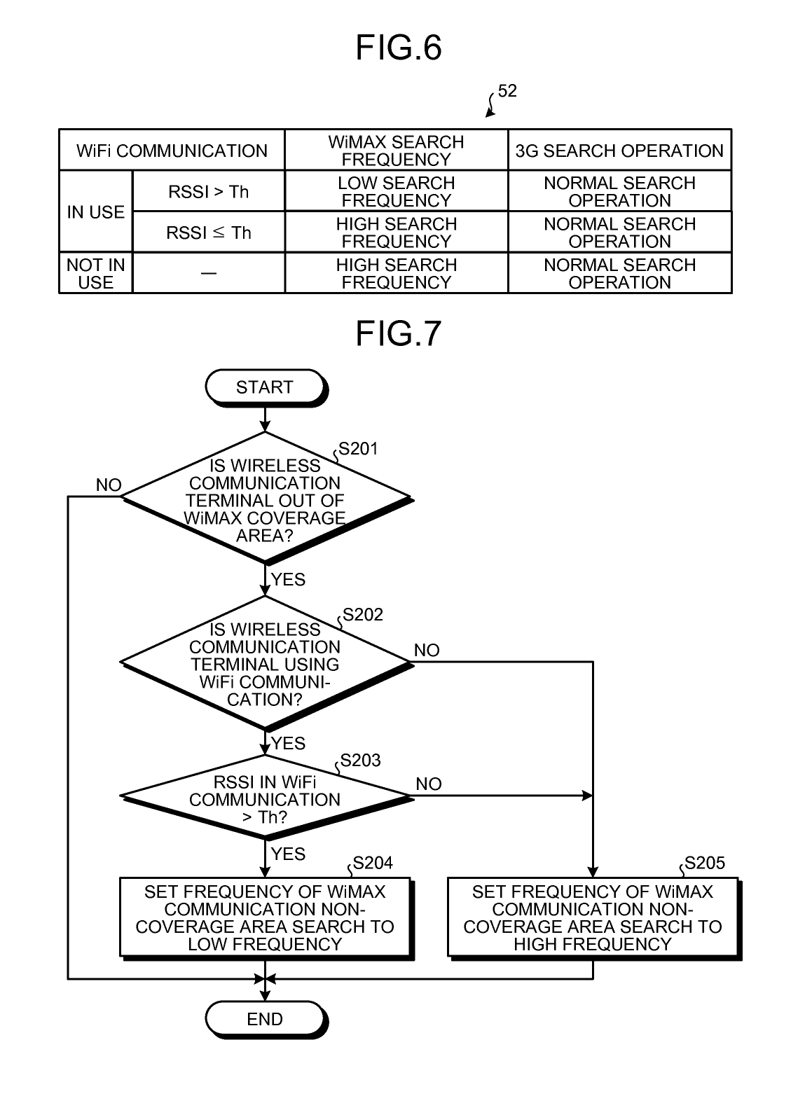

The search control unit 37 stores therein a search-frequency determining table 52 as illustrated in FIG. 6. FIG. 6 is a diagram of an example of the search-frequency determining table according to the second embodiment. In FIG. 6, electric field strength is denoted by RSSI.

When received a notification of the wireless communication terminal 1 being out of a WiMAX coverage area from the WiMAX coverage area search processing unit 33, the search control unit 37 acquires a data communication method being used in communication from the usage-state managing unit 38. When the wireless communication terminal 1 is in communication using WiFi communication as the data communication method, the search control unit 37 acquires identification information of a destination base station in the WiFi communication. Then, the search control unit 37 acquires electric field strength of the destination base station from the electric field strength received from the WiFi coverage area search processing unit 32. The search control unit 37 determines whether the acquired electric field strength is higher than a threshold (Th).

Then, when the electric field strength is higher than the threshold (Th), the search control unit 37 determines the search frequency to be a low search frequency with reference to the search-frequency determining table 52. Furthermore, when the electric field strength is equal to or lower than the threshold (Th), the search control unit 37 determines the search frequency to be a high search frequency with reference to the search-frequency determining table 52. On the other hand, when the wireless communication terminal 1 is not in communication using WiFi communication as the data communication method, the search control unit 37 determines the search frequency to be a high search frequency regardless of electric field strength in 3G communication. Then, the search control unit 37 instructs the WiMAX non-coverage area search processing unit 36 to perform a non-coverage area search at the determined frequency.

Furthermore, when received a notification of a change in the data communication method from the usage-state managing unit 38, the search control unit 37 determines whether the wireless communication terminal 1 is out of WiMAX communication service. When the wireless communication terminal 1 is out of WiMAX communication service, the search control unit 37 performs the non-coverage area search frequency determining process in the same manner as when received the notification of the wireless communication terminal 1 being out of a WiMAX coverage area from the WiMAX coverage area search processing unit 33.

Here, it is preferable to set the threshold (Th) so as to meet the communication system operation. For example, to avoid a decrease in the transmission rate as much as possible, it is preferable to set the threshold (Th) to a high threshold, thereby making it easy to ensure the switching to WiMAX communication. Furthermore, to suppress power consumption as low as possible, it is preferable to set the threshold (Th) to a low threshold, thereby reducing execution of a non-coverage area search in WiMAX communication. Moreover, it is preferable to set the threshold (Th) appropriately taking into account a WiMAX communication environment and communication environments of the other data communications, etc.

Subsequently, a WiMAX communication non-coverage area search frequency determining process performed by the wireless communication terminal according to the present embodiment is explained with reference to FIG. 7. FIG. 7 is a flowchart of the WiMAX communication non-coverage area search frequency determining process in the second embodiment. Here, there is described a case where the data communication method is changed.

Upon receipt of a notification of the change in the data communication method from the usage-state managing unit 38, the search control unit 37 determines whether the wireless communication terminal 1 is out of a WiMAX coverage area (Step S201). When the wireless communication terminal 1 is within the WiMAX coverage area (NO at Step S201), the search control unit 37 does not issue an instruction to perform a non-coverage area search, and ends the non-coverage area search frequency determining process.

On the other hand, when the wireless communication terminal 1 is out of the WiMAX coverage area (YES at Step S201), the search control unit 37 determines whether the wireless communication terminal 1 is using WiFi communication (Step S202). When the wireless communication terminal 1 is using WiFi communication (YES at Step S202), the search control unit 37 determines whether electric field strength (RSSI) in the WiFi communication is higher than the threshold (Th) (Step S203). When the electric field strength in the WiFi communication is higher than the threshold (YES at Step S203), the search control unit 37 determines to set the frequency of WiMAX communication non-coverage area search to a low frequency (Step S204).

On the other hand, when the wireless communication terminal 1 is not using WiFi communication (NO at Step S202) or when the electric field strength in the WiFi communication is equal to or lower than the threshold (NO at Step S203), the search control unit 37 determines to set the frequency of WiMAX communication non-coverage area search to a high frequency (Step S205).

In the flow of FIG. 7, there is described the case where the data communication method is changed; furthermore, when the wireless communication terminal 1 has moved from inside to outside of the WiMAX coverage area, the search control unit 37 performs the processes at Steps S202 to S205 and determines the frequency of non-coverage area search in WiMAX communication.

Here, there is explained the reason why the frequency of WiMAX communication non-coverage area search can be lowered. When the wireless communication terminal is using WiFi communication and also the radio quality is good, the wireless communication terminal is unlikely to switch the data communication method to another data communication method. Therefore, when the wireless communication terminal is using WiFi communication in the condition of the good radio quality, it doesn't matter if the frequency of non-coverage area search in WiMAX communication having a lower priority than that of WiFi communication is lowered. Furthermore, also when the wireless communication terminal 1 is out of a communication area of WiFi communication, the communication continuity is ensured by 3G communication covering the widest communication area. Therefore, even if the wireless communication terminal 1 is out of the communication area for WiFi communication in a state where the wireless communication terminal 1 has not detected a base station for WiMAX communication because the search frequency in WiMAX communication is lowered, communication is continued by 3G communication. Moreover, when the data communication method is switched from WiFi communication to 3G communication, the frequency of WiMAX communication non-coverage area search is increased; thus, the wireless communication terminal 1 immediately detects a base station for WiMAX communication and switches from 3G communication to WiMAX communication, so a high transmission rate can be immediately ensured.

As described above, when the wireless communication terminal according to the present embodiment performs WiFi communication and also electric field strength in the WiFi communication is higher than the threshold, the wireless communication terminal lowers the frequency of non-coverage area search in WiMAX communication. Consequently, when WiFi communication is in a good communication state, i.e., when WiFi communication is considered to be continued, it is possible to reduce electric power consumed in WiMAX communication non-coverage area search.

### [c] Third Embodiment

Subsequently, a third embodiment is explained. A wireless communication terminal according to the present embodiment differs from the wireless communication terminal according to the second embodiment in that a 3G communication state is further added in the conditions for determination of the search frequency in WiMAX communication. So, a search-frequency determining process taking into account a 3G communication state is mainly explained below. The wireless communication terminal according to the present embodiment is also expressed in the block diagram illustrated in FIG. 2. In the description below, a unit having the same reference numeral as in the first embodiment shall have the same function unless otherwise stated.

The WiFi coverage area search processing unit 32 outputs identification information of a base station and measured electric field strength to the communication control unit 39 and the search control unit 37.

When the wireless communication terminal is within a 3G coverage area, the 3G coverage area search processing unit 31 outputs identification information of a base station and measured electric field strength to the communication control unit 39 and the search control unit 37. When the wireless communication terminal is out of the 3G coverage area, the 3G non-coverage area search processing unit 34 outputs identification information of a base station and measured electric field strength to the communication control unit 39 and the search control unit 37.

The communication control unit 39 notifies the usage-state managing unit 38 of a data communication method being used in communication and identification information of a base station to connect to.

When received the data communication method and the identification information of the base station to connect to from the communication control unit 39, the usage-state managing unit 38 notifies the search control unit 37 of these. Furthermore, the usage-state managing unit 38 stores therein the received data communication method being used in communication and identification information of the other end of the communication, i.e., the base station to connect to.

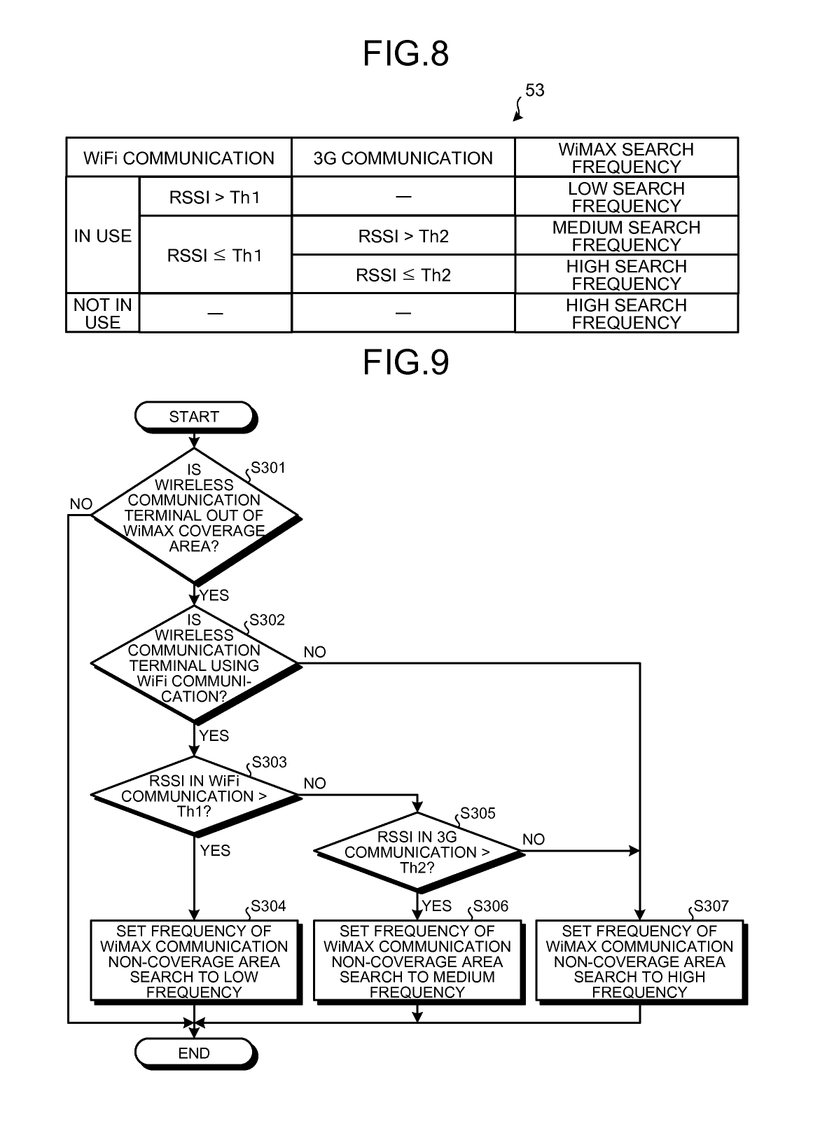

The search control unit 37 stores therein a search-frequency determining table 53 as illustrated in FIG. 8. FIG. 8 is a diagram of an example of the search-frequency determining table according to the third embodiment. In FIG. 8, electric field strength is denoted by RSSI.

When received a notification of the wireless communication terminal 1 being out of a WiMAX coverage area from the WiMAX coverage area search processing unit 33, the search control unit 37 acquires a data communication method being used in communication from the usage-state managing unit 38. When the wireless communication terminal 1 is in communication using WiFi communication as the data communication method, the search control unit 37 acquires identification information of a destination base station in the WiFi communication. Then, the search control unit 37 acquires electric field strength of the destination base station in the WiFi communication from the electric field strength received from the WiFi coverage area search processing unit 32. Furthermore, when the wireless communication terminal 1 is within a 3G coverage area, the search control unit 37 acquires electric field strength in 3G communication from the 3G coverage area search processing unit 31. When the wireless communication terminal 1 is out of the 3G coverage area, the search control unit 37 acquires electric field strength in 3G communication from the 3G non-coverage area search processing unit 34. The search control unit 37 determines whether the acquired electric field strength in the WiFi communication is higher than a threshold (Th1). Furthermore, the search control unit 37 determines whether the acquired electric field strength in the 3G communication is higher than a threshold (Th2).

Then, when the electric field strength in the WiFi communication is higher than the threshold (Th1), regardless of the electric field strength in the 3G communication, the search control unit 37 determines the search frequency to be a low search frequency with reference to the search-frequency determining table 53. Furthermore, when the electric field strength in the WiFi communication is equal to or lower than the threshold (Th1) and the electric field strength in the 3G communication is higher than the threshold (Th2), the search control unit 37 determines the search frequency to be a medium search frequency with reference to the search-frequency determining table 53. Moreover, when the electric field strength in the WiFi communication is equal to or lower than the threshold (Th1) and the electric field strength in the 3G communication is equal to or lower than the threshold (Th2), the search control unit 37 determines the search frequency to be a high search frequency with reference to the search-frequency determining table 53. On the other hand, when the wireless communication terminal 1 is not in communication using WiFi communication as the data communication method, the search control unit 37 determines the search frequency to be a high search frequency regardless of electric field strength in 3G communication. Then, the search control unit 37 instructs the WiMAX non-coverage area search processing unit 36 to perform a non-coverage area search at the determined frequency.

For example, in the present embodiment, the high search frequency shall be a frequency of once every 5 to 10 seconds, the low search frequency shall be no non-coverage area search to be made, and the medium search frequency shall be a frequency in between the high search frequency and the low search frequency (for example, once every minute).

Furthermore, when received a notification of a change in the data communication method from the usage-state managing unit 38, the search control unit 37 determines whether the wireless communication terminal 1 is out of WiMAX communication service. When the wireless communication terminal 1 is out of WiMAX communication service, the search control unit 37 performs the non-coverage area search frequency determining process in the same manner as when received the notification of the wireless communication terminal 1 being out of a WiMAX coverage area from the WiMAX coverage area search processing unit 33.

Here, it is preferable to set the threshold (Th1) and the threshold (Th2) so as to meet the communication system operation. For example, to increase the communication continuity higher, it is preferable to set the threshold (Th2) to a higher threshold, thereby making it possible to perform WiMAX communication certainly in case 3G communication is not performed. Furthermore, to suppress power consumption as low as possible, it is preferable to set the threshold (Th2) to a lower threshold, thereby reducing execution of a non-coverage area search in WiMAX communication. Moreover, it is preferable to set the respective thresholds appropriately taking into account a WiMAX communication environment and a 3G communication environment, etc.

Subsequently, a WiMAX non-coverage area search frequency determining process performed by the wireless communication terminal according to the present embodiment is explained with reference to FIG. 9. FIG. 9 is a flowchart of the WiMAX non-coverage area search frequency determining process in the third embodiment. Here, there is described a case where the data communication method is changed.

Upon receipt of a notification of the change in the data communication method from the usage-state managing unit 38, the search control unit 37 determines whether the wireless communication terminal 1 is out of a WiMAX coverage area (Step S301). When the wireless communication terminal 1 is within the WiMAX coverage area (NO at Step S301), the search control unit 37 does not issue an instruction to perform a non-coverage area search, and ends the non-coverage area search frequency determining process.

On the other hand, when the wireless communication terminal 1 is out of the WiMAX coverage area (YES at Step S301), the search control unit 37 determines whether the wireless communication terminal 1 is using WiFi communication (Step S302). When the wireless communication terminal 1 is using WiFi communication (YES at Step S302), the search control unit 37 determines whether electric field strength (RSSI) in the WiFi communication is higher than the threshold (Th1) (Step S303). When the electric field strength in the WiFi communication is higher than the threshold (YES at Step S303), the search control unit 37 determines to set the frequency of WiMAX communication non-coverage area search to a low frequency (Step S304).

On the other hand, when the electric field strength in the WiFi communication is equal to or lower than the threshold (NO at Step S303), the search control unit 37 determines whether electric field strength (RSSI) in 3G communication is higher than the threshold (Th2) (Step S305). When the electric field strength in the WiFi communication is higher than the threshold (YES at Step S305), the search control unit 37 determines to set the frequency of WiMAX communication non-coverage area search to a medium frequency (Step S306).

On the other hand, when the wireless communication terminal 1 is not using WiFi communication (NO at Step S302) or when the electric field strength in the 3G communication is equal to or lower than the threshold (NO at Step S305), the search control unit 37 determines to set the frequency of WiMAX communication non-coverage area search to a high frequency (Step S307).

In the flow of FIG. 9, there is described the case where the data communication method is changed; furthermore, when the wireless communication terminal 1 has moved from inside to outside of the WiMAX coverage area, the search control unit 37 performs the processes at Steps S302 to S307 and determines the frequency of non-coverage area search in WiMAX communication.

Here, there is explained the reason why the frequency of WiMAX communication non-coverage area search is determined as described above depending on the radio quality in 3G communication and WiFi communication. Even when, although the wireless communication terminal 1 is using WiFi communication, the radio quality has deteriorated, if the radio quality in 3G communication covering the widest communication area is high, the communication continuity is ensured by the 3G communication even if WiFi communication is out of service. Therefore, for example, when the wireless communication terminal 1 performing WiFi communication is out of a WiFi communication area in a state where the wireless communication terminal 1 has not detected a base station for WiMAX communication because the search frequency in WiMAX communication is lowered, communication is continued by 3G communication. On the other hand, in a condition where the radio quality in both WiFi communication and 3G communication has deteriorated, there is a case that the communication continuity is not maintained by only the WiFi communication and 3G communication; therefore, it is preferable to perform a WiMAX communication non-coverage area search. For such a reason, the frequency of WiMAX communication non-coverage area search is determined depending on the radio quality in 3G communication and WiFi communication as described above.

As described above, the wireless communication terminal according to the present embodiment changes the frequency of WiMAX communication non-coverage area search depending on respective electric field strengths in WiFi communication and 3G communication. Consequently, when WiFi communication is in a good communication state, i.e., when WiFi communication is considered to be continued, it is possible to reduce electric power consumed in WiMAX communication non-coverage area search. Furthermore, even when WiFi communication is in a bad communication state, if 3G communication is in a good communication state and the communication continuity is ensured, it is possible to reduce a certain amount of electric power consumed in WiMAX communication non-coverage area search.

[Hardware Configuration]

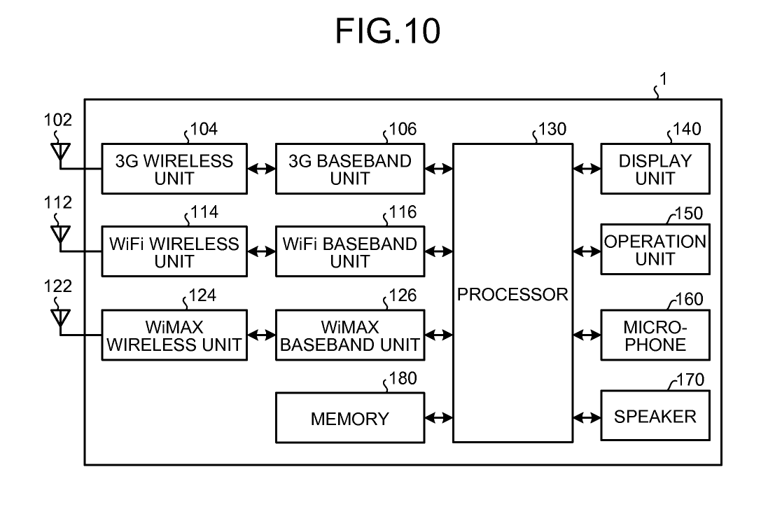

Subsequently, a hardware configuration of the wireless communication terminal according to the embodiments is explained with reference to FIG. 10. FIG. 10 is a diagram illustrating the hardware configuration of the wireless communication terminal.

The wireless communication terminal 1 according to the above-described embodiments includes antennas 102, 112, and 122, a 3G wireless unit 104, a WiFi wireless unit 114, a WiMAX wireless unit 124, a 3G baseband unit 106, a WiFi baseband unit 116, and a WiMAX baseband unit 126. Furthermore, the wireless communication terminal 1 includes a processor 130, a display unit 140, an operation unit 150, a microphone 160, a speaker 170, and a memory 180.

The 3G wireless unit 104, the WiFi wireless unit 114, and the WiMAX wireless unit 124 each include an oscillator, a multiplier, an amplifier, an attenuator, and an AGC, etc. The 3G wireless unit 104 is connected to the antenna 102, and implements, for example, the function of the 3G wireless control unit 11 illustrated in FIG. 2. The WiFi wireless unit 114 is connected to the antenna 112, and implements, for example, the function of the WiFi wireless control unit 12 illustrated in FIG. 2. The WiMAX wireless unit 124 is connected to the antenna 122, and implements, for example, the function of the WiMAX wireless control unit 13 illustrated in FIG. 2.

The 3G baseband unit 106, the WiFi baseband unit 116, and the WiMAX baseband unit 126 each include a modulator and a demodulator, etc. The 3G baseband unit 106 is connected to the 3G wireless unit 104 and the processor 130, and implements, for example, the function of the 3G baseband processing unit 21 illustrated in FIG. 2. The WiFi baseband unit 116 is connected to the WiFi wireless unit 114 and the processor 130, and implements, for example, the function of the WiFi baseband processing unit 22 illustrated in FIG. 2. The WiMAX baseband unit 126 is connected to the WiMAX wireless unit 124 and the processor 130, and implements, for example, the function of the WiMAX baseband processing unit 23 illustrated in FIG. 2.

The memory 180, the display unit 140, the operation unit 150, the microphone 160, and the speaker 170 are connected to the processor 130.

The display unit 140 includes, for example, a liquid crystal display or the like, and displays thereon respective electric field strengths of 3G, WiMAX, and WiFi, a service state or an out-of-service state, and a communication state, etc. in the form of an increase or decrease of antennas and the form of icons, etc. The display unit 140 operates under the control of the processor 130.

The operation unit 150 is a user interface for the control of start/end of a communication application, and includes, for example, buttons or a touch screen, etc. The operation unit 150 inputs information input through the touch screen or the like to the processor 130.

The microphone 160 receives a voice signal. The speaker 170 outputs an audio signal. The microphone 160 and the speaker 170 each include a coding unit and a decoding unit.

The processor 130 and the memory 180 implement, for example, the function of the control unit 30 illustrated in FIG. 2. Specifically, the memory 180 stores therein various programs, such as a program for implementing the process performed by the communication control unit 39, the usage-state managing unit 38, and the search control unit 37, etc. illustrated in FIG. 2. The processor 130 reads out these programs from the memory 180 and executes the programs, thereby generating processes for implementing the above-described functions.

Accordingly, it is an object in one aspect of an embodiment of the invention to reduce power consumption.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication terminal comprising:
a wireless communication unit that selects one data communication method from a plurality of data communication methods, and performs communication using the selected data communication method;
a search processing unit that detects a base station supporting a data communication method other than the data communication method selected by the wireless communication unit; and
a search control unit that controls frequency of execution of a base-station detecting process performed by the search processing unit using the data communication method other than the data communication method being used in the communication on the basis of respective communication states and predetermined priorities of the plurality of data communication methods.

2. The wireless communication terminal according to claim 1, wherein
when the wireless communication unit is not performing communication using a highest-priority data communication method, the search control unit sets the frequency of execution of the base-station detecting process performed by the search processing unit using another data communication method, which has lower priority than the highest-priority data communication method, to be a predetermined frequency, and
when the wireless communication unit is performing communication using the highest-priority data communication method, the search control unit sets the frequency of execution of the base-station detecting process performed by the search processing unit using the other data communication method to be a frequency lower than the predetermined frequency.

3. The wireless communication terminal according to claim 1, wherein in a case where the wireless communication unit is performing communication using a highest-priority data communication method,
when electric field strength of the highest-priority data communication method is equal to or lower than a predetermined value, the search control unit sets the frequency of execution of the base-station detecting process performed by the search processing unit using another data communication method, which has lower priority than the highest-priority data communication method, to be a predetermined frequency, and
when electric field strength of the highest-priority data communication method is higher than the predetermined value, the search control unit sets the frequency of execution of the base-station detecting process performed by the search processing unit using another data communication method to be a frequency lower than the predetermined frequency.

4. The wireless communication terminal according to claim 1, wherein the search control unit uses priorities of which the order is determined so that the higher transmission rate a data communication method has, the higher priority the data communication method has.

5. The wireless communication terminal according to claim 1, wherein in a case where the priorities includes a first priority and a second priority, and the wireless communication unit is performing communication using a first data communication method having the highest first priority,
when electric field strength of the first data communication method is higher than a predetermined value, the search control unit sets the frequency of execution of the base-station detecting process performed by the search processing unit using a low-priority data communication method other than the first data communication method and a second data communication method having the highest second priority to be a first frequency,
when electric field strength of the first data communication method is equal to or lower than the predetermined value and also electric field strength of the second data communication method is equal to or lower than the predetermined value, the search control unit sets the frequency of execution of the base-station detecting process performed by the search processing unit using the low-priority data communication method to be a second frequency higher than the first frequency, and
when electric field strength of the first data communication method is equal to or lower than the predetermined value and also electric field strength of the second data communication method is higher than the predetermined value, the search control unit sets the frequency of execution of the base-station detecting process performed by the search processing unit using the low-priority data communication method to be a third frequency which is higher than the first frequency and lower than the second frequency.

6. The wireless communication terminal according to claim 5, wherein
as the first priority, the search control unit uses priorities of which the order is determined so that the higher transmission rate a data communication method has, the higher priority the data communication method has, and
as the second priority, the search control unit uses priorities of which the order is determined so that the wider communication area in one base station a data communication method has, the higher priority the data communication method has.

7. The wireless communication terminal according to claim 1, wherein
the search processing unit implements two different search systems: a non-coverage area search and a coverage area search,
the non-coverage area search is to detect a base station capable of communication using a particular data communication method when the wireless communication terminal is out of a coverage area of the communication using the particular data communication method; and
the coverage area search is to detect a base station capable of communication using a particular data communication method when the wireless communication terminal is within a coverage area of the communication using the particular data communication method, and
the search control unit controls a detection method in the non-coverage area search performed by the search processing unit.

8. The wireless communication terminal according to claim 1, further comprising a handover processing unit that performs handover to switch an access point to a base station detected by the search processing unit when communication with a currently-connected base station meets a predetermined condition.

9. A method for controlling a wireless communication terminal, the method comprising:
selecting one data communication method from a plurality of data communication methods and performing communication using the selected data communication method;
controlling frequency of execution of a base-station detecting process using a data communication method other than the data communication method being used in the communication on the basis of respective communication states and predetermined priorities of the plurality of data communication methods; and
detecting a base station supporting a data communication method other than the data communication method being used in the communication in response to the control of the frequency of execution of the base-station detecting process.

10. A wireless communication terminal comprising:
a memory; and
a processor connected to the memory, wherein
the processor executes:
selecting one data communication method from a plurality of data communication methods;
performing communication using the selected data communication method;
detecting a base station supporting a data communication method other than the selected data communication method; and
controlling frequency of execution of a process at the detecting on the basis of respective communication states and predetermined priorities of the plurality of data communication methods.
